(19) United States
(12) Patent Application Publication
(10) Pub. No.: US 2013/0078065 A1
(43) Pub. Date: Mar. 28, 2013

(54) Cargo Lift Apparatus

(71) Applicant: Kenneth Butler, Louisville, MS (US)

(72) Inventor: Kenneth Butler, Louisville, MS (US)

(21) Appl. No.: 13/239,624

(22) Filed: Sep. 22, 2011

(51) Int. Cl. B60P 1/04

(52) U.S. Cl. 414/462

(57) ABSTRACT

The present invention comprises a cargo lift designed to allow an individual to lift heavy objects from the ground, onto the back of an all-terrain vehicle, without other mechanical assistance. The invention comprises a novel lifting mechanism based on an unconventional use of dampers that can be lowered into position using a small amount of force and can raise a heavy object without the use of hydraulic pumps, electricity, or other energy sources that may be impractical in remote areas. The lift stores the user's downward force as potential energy and releases that force as kinetic energy to lift the cargo.

### FIELD OF THE INVENTION

The present invention relates generally to wild game and cargo lifts and specifically to a cargo lift that uses dampers to lift wild game and cargo.

### BACKGROUND OF THE INVENTION

Sportsmen and outdoor enthusiasts often need to transport cargo to and from remote areas. Hunters often transport wild game from remote locations back to their domiciles, and forestry and farming professionals often need to transport equipment or materials to and from remote locations. Often, these locations are completely inaccessible to traditional vehicles. For this reason, these individuals employ all terrain vehicles and similar vehicles to access these areas. These vehicles are capable of carrying relatively heavy loads, such as large wild game, large sacks of game feed, construction materials, and the like. However, individuals are often unable to lift such a load from the ground and place it on the ATV without difficulty.

Many game lifts have been created to solve this need. Some lifts employ a hand crank to raise the cargo from the ground. These lifts are ill suited to heavy loads because they employ the arm strength of the user to raise the cargo. While more efficient than requiring the user to lift the cargo by main strength, this design still requires significant exertion by the user and may not be usable by weaker users. Other lifts require the user to secure the lift to the ground or a stationary object. The user then uses the vehicles forward motion to raise the lift. These lifts are impractical because they can only be used on a specific terrain or when in close proximity to the proper anchor. Other lifts requires a power source to lift the cargo. These lifts are not optimal because they either require a modification of the vehicle or the presence of a power source nearby, which is unlikely when deployed in remote or wilderness areas.

Therefore, what is needed is a cargo lift apparatus. The cargo lift apparatus should lift cargo without extensive exertion from the user. The cargo lift apparatus should also be usable without regard to the terrain upon which it is used. The cargo lift apparatus should also be useable without significant modification of the vehicle to which it is attached or the presence of a power source in close proximity. Furthermore, other desirable features and characteristics of the present invention will become apparent when this background of the invention is read in conjunction with the subsequent detailed description of the invention, appended claims, and the accompanying drawings.

### SUMMARY OF THE INVENTION

The present invention advantageously fills the aforementioned deficiencies by providing a cargo lift apparatus. The cargo lift apparatus should be capable of lifting cargo without regard to the user's physical strength or the terrain in which it is deployed. The cargo lift apparatus should also be usable in the absence of a power source.

The present invention now will be described more fully hereinafter with reference to the accompanying drawings, which are intended to be read in conjunction with both this summary, the detailed description, and any preferred and/or particular embodiments specifically discussed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The drawings contained herein exemplify one of the embodiments of the claimed invention. The invention is not limited to the embodiment shown. The embodiment shown is purely an example, and the invention is capable of many variations of said embodiment. In the drawings,

FIG. 1 illustrates a perspective view of an embodiment of the present invention in a cargo receiving position;

FIG. 2 illustrates a perspective view of an embodiment of the present invention in a lifted position;

FIG. 3 illustrates perspective view the base member in a lowered position in an embodiment of the present invention;

FIG. 4 illustrates a perspective view of the locking unit in an embodiment of the present invention.

FIG. 5 illustrates a perspective view of the control unit in an embodiment of the present invention.

The first digit of each reference numeral in the above figures indicates the figure in which an element or feature is most prominently shown. The second digit indicates related elements or features, and a final letter (when used) indicates a sub-portion of an element or feature.

### DETAILED DESCRIPTION OF THE INVENTION

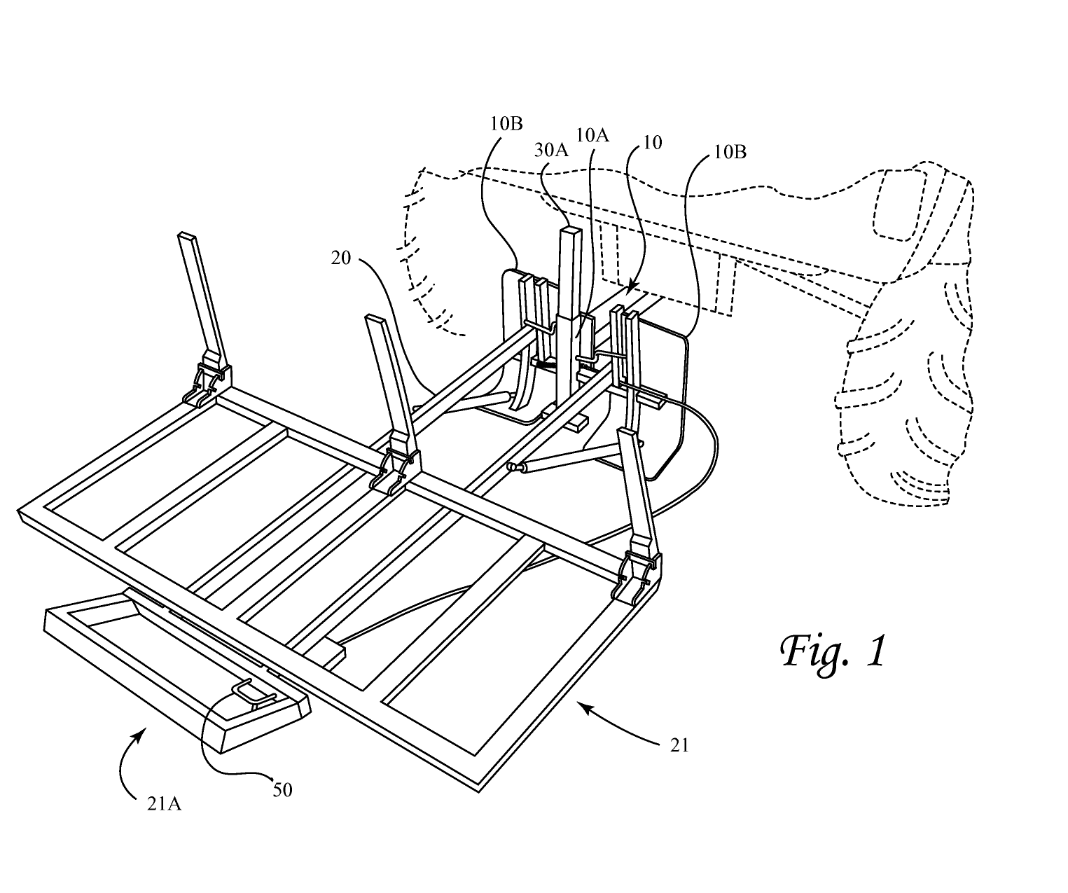

FIG. 1 illustrates a perspective view of an embodiment of the present invention in a cargo receiving position. The cargo lift apparatus comprises a vehicle mount 10. The vehicle mount 10 should be capable of being releaseably attached to a vehicle trailer hitch which. One standard trailer hitch design commonly installed on most all terrain vehicles (ATVs) comprises a hollow rectangular prism with round perforations at regular intervals. In the preferred embodiment of the present invention, the vehicle mount 10 should comprise a rectangular prism of slightly smaller size than a standard trailer hitch with similarly situated round perforations. This allows the vehicle mount 10 to slide inside the standard ATV hitch and be secured by a removable pin or similar device placed through the perforations in the vehicle mount 10 and the trailer hitch. One skilled in the art will understand that many trailer hitch designs are commonly available, and that a vehicle mount 10 can be easily modified to releasably attach to these designs. This disclosure is intended to and does include these variants. The vehicle mount 10 should further comprise an attachment assembly 10A. The attachment assembly 10A serves as an attachment point for other components. In the preferred embodiment, the vehicle mount 10 further comprises one or more protective shields 10B. The protective shields 10B should shield the other components of the apparatus from foreign material such as mud or similar debris that is ejected from the vehicle's tires during transit.

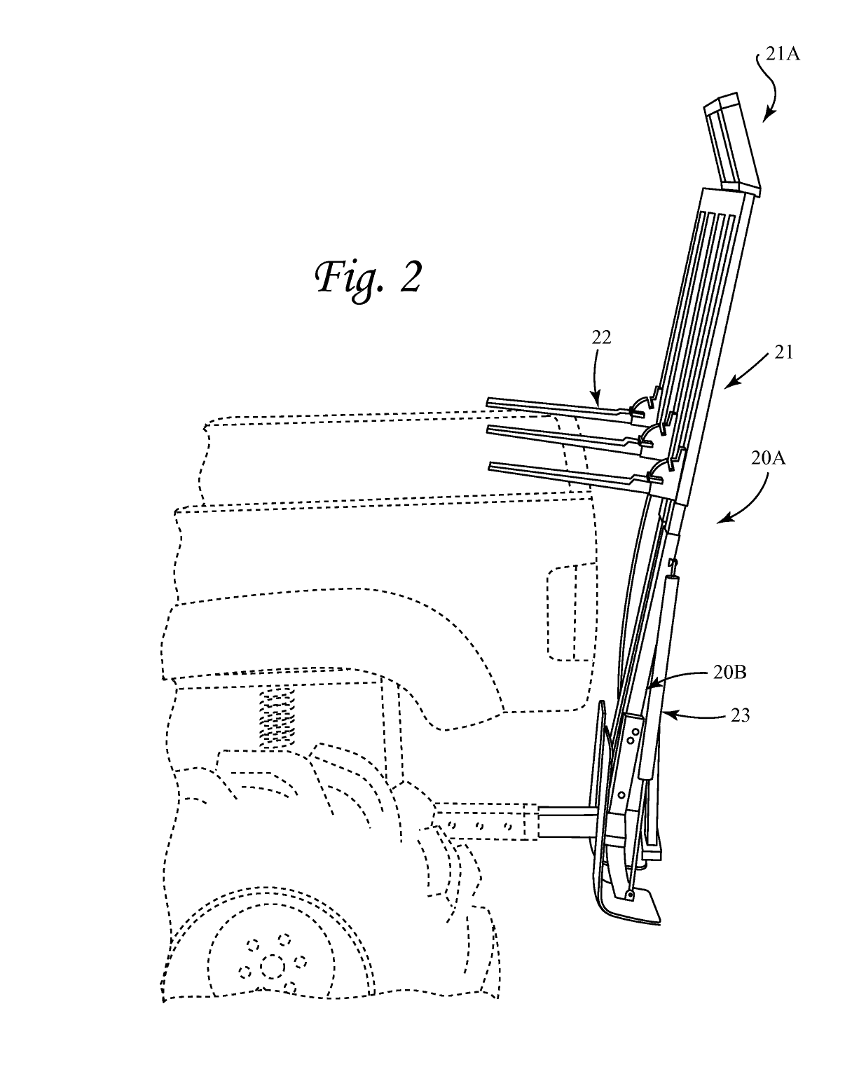

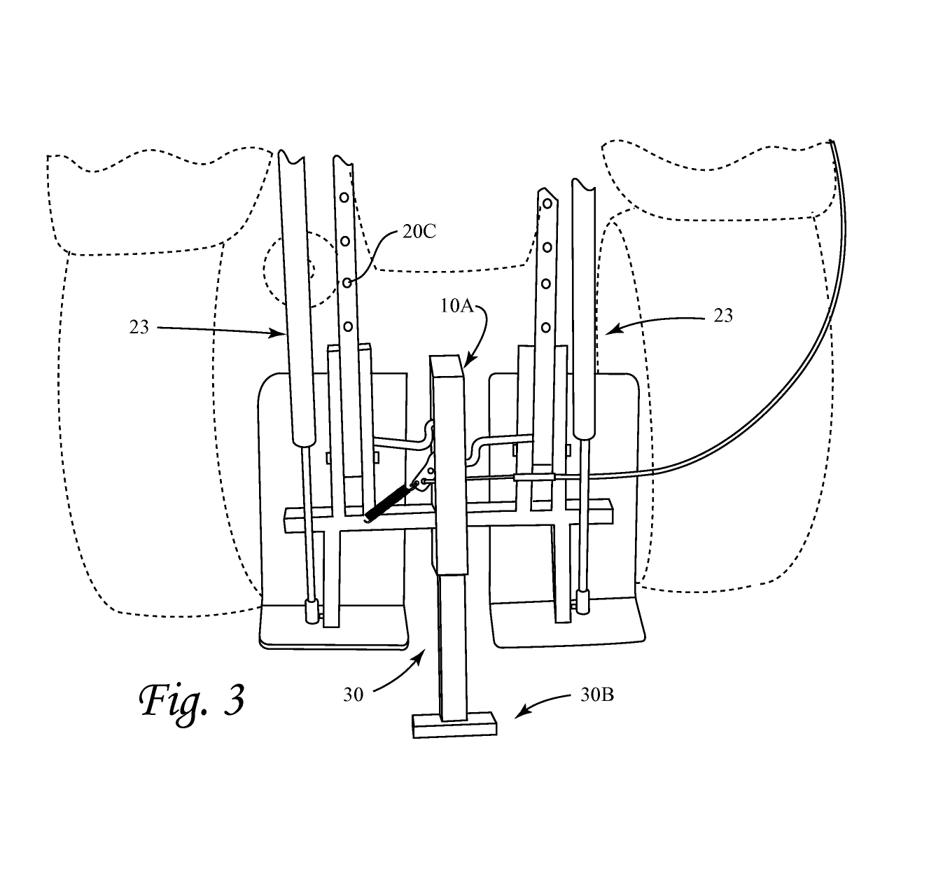

The cargo lift further comprises one or more support members 20 pivotally attached to the attachment assembly 10A of the vehicle mount 10. In the preferred embodiment, the support members 20 are allowed to pivot approximately ninety degrees around the axis created by the point of attachment between the support members 20 and the attachment assembly 10A. FIG. 1 illustrates the support members 20 in a cargo receiving position, while FIG. 2 illustrates the support members in a cargo lifted position. Referring to FIG. 2, in the preferred embodiment, the support members 20 each further comprise a proximate portion 20A, a distal portion 20B, and an attachment means 20C. The proximate portion 20A should be attached to other components as discussed below. The distal portion 20B should be pivotally attached to the attachment assembly of the vehicle mount 10A. The proximate portion 20A should be slideably received by the distal portion 20B and adjustably retained in position by an attachment means 20C. In this configuration, the length of the support members 20 may be increased or decreased as needed by the user. Briefly referring to FIG. 3, in the preferred embodiment, the attachment means 20C comprises a pin placed into perforations in both the proximate portion 20A and distal portion 20B. However, one skilled in the art will recognize that many variations of the attachment means 20C may be employed within the scope of the present invention.

As seen in FIG. 2, the cargo lift further comprises a basket member 21 capable of accepting and retaining cargo. The basket member 21 should be attached to the proximate portions of the support members 20A so that the basket member 21 can be raised and lowered into the lifted and receiving positions as needed. In the preferred embodiment, the basket member further comprises a handle 21A. The handle 21A may be employed by the user to guide the basket member 21 into various positions. It should be noted that other components provide the main lifting force needed to operate the apparatus, and that the handle 21A is provided only to assist the user. One skilled in the art will understand that the handle 21A may be omitted in some embodiments. It should also be noted that the position of the basket member 21 may also be adjusted by altering the length of the support members 20 as discussed hereinabove.

In the preferred embodiment, the cargo lift apparatus should further comprise one or more retaining members 22 pivotally attached to the basket member 21. The retaining members 22 allow the basket member 22 to retain cargo when in the lifted position as shown in FIG. 2. In the preferred embodiment, three retaining members 22 are employed. However, differing numbers of retaining members 22 may be employed depending on the needs of the user and cost constraints. The retaining members 22 should be pivotally attached to allow the retaining members 22 to be closed when not in use. One skilled in the art will recognize that, while the retaining members 22 are useful in practicing the present invention, many substitute devices may be employed to serve the same purpose. This disclosure is intended and does include those variants.

The apparatus further comprises one or more dampers 23. The dampers 23 should be pivotally attached to the attachment assembly 10A and also pivotally attached to a support member 20. The dampers 23 provide the force necessary to lift any cargo loaded into the basket member 21. The dampers 23 should each be capable of storing rotational kinetic energy received from the attached support member 20, and capable of releasing stored energy as rotational kinetic energy into the attached support member 20. In the preferred embodiment, two dampers 23 are employed. However, one skilled in the art will recognize that varying numbers of dampers 23 could be employed within the scope of this invention. A user loading cargo with the present invention may press down on the basket member 21 to place the apparatus into the cargo receiving position. The user may use the force of his weight to press the basket member 21 and attached support members 20 down. The dampers 23 which are attached to the support members 20 store the downward force. Once the support members 20 depress the dampers 23 to into the cargo receiving position, the dampers 23 release the stored energy to lift the basket member 21 with any associated cargo. One skilled in the art will recognize that many different dampers 23 may be used in the present invention. Depending on the dampers 23 selected, greater or lesser force is required to place the basket member 21 into the cargo receiving position. Also depending on the dampers 23 selected greater cargo weights may be lifted. Depending on the design of the dampers 23 selected, the downward force necessary to place the apparatus into the cargo receiving position may be significantly less than the resultant upward force released by the damper 23. This allows relatively heavy loads to be lifted while using relatively little downward force to place the apparatus into the cargo receiving position. In an alternate embodiment of the present invention (not pictured) four dampers 23 are employed to lift heavy game. Depending on the dampers 23 selected, the four damper 23 embodiment can exert up to around one thousand one hundred pounds of upward pressure while requiring the user to exert about forty to sixty pounds of downward pressure when placing the embodiment onto the cargo receiving position.

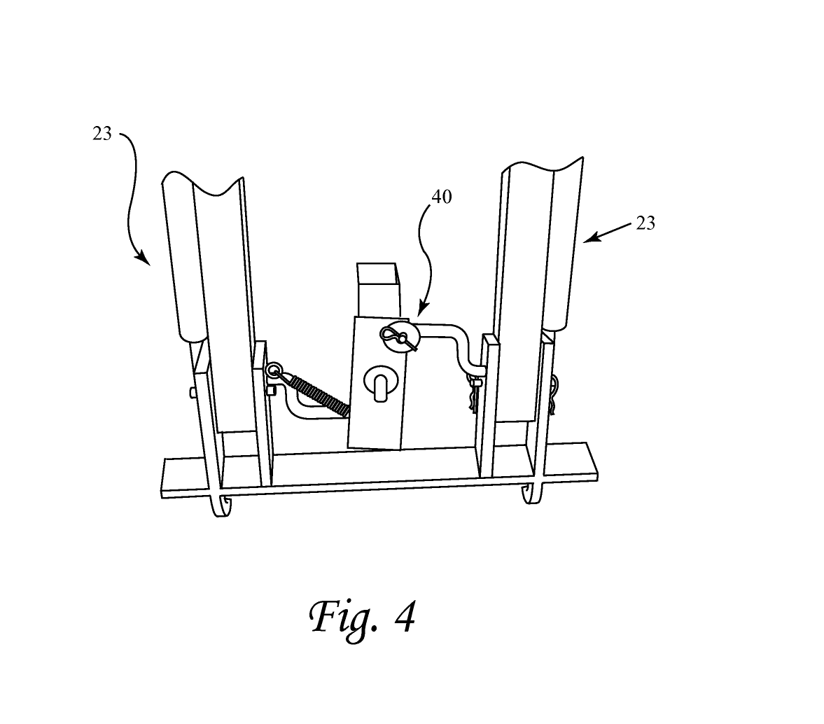

Briefly referring to FIG. 4, the present invention further comprises a locking unit 40. The locking unit 40 should be attached to the vehicle mount attachment assembly 10A and should be capable of releasably locking the support members 20 and attached dampers 23 in an energy storing position. In the preferred embodiment, the locking unit 40 locks the support members 20 into place when the user presses the apparatus into the cargo receiving position. The user may then load any cargo, unlock the locking unit 40, and allow the dampers 23 to raise the support members 20 and the attached basket member 21 into the lifted position. In the preferred embodiment, the locking unit 40 is comprised of a bars attached to a circular movable base which is attached to the attachment assembly 10A. The locking unit 40 further comprises a spring. The spring causes the base to rotate and places the bars between the attachment assembly 10A and the support members 20. This configuration allows the support members 20 to move until they reach a pre-determined point at which time the spring of the locking unit 40 forces the bars into place and prevents the support members 20 from rising again due to energy release from the dampers 23. In the preferred embodiment, other components are connected to the locking unit 40 to allow the unit to release the support members 20 as discussed below. One skilled in the art will recognize that the present locking unit 40 is merely one configuration to prevent the support members 20 from rising until the user releases them. Many variations of the locking unit 40 exist. This disclosure is intended to disclose and does disclose those embodiments.

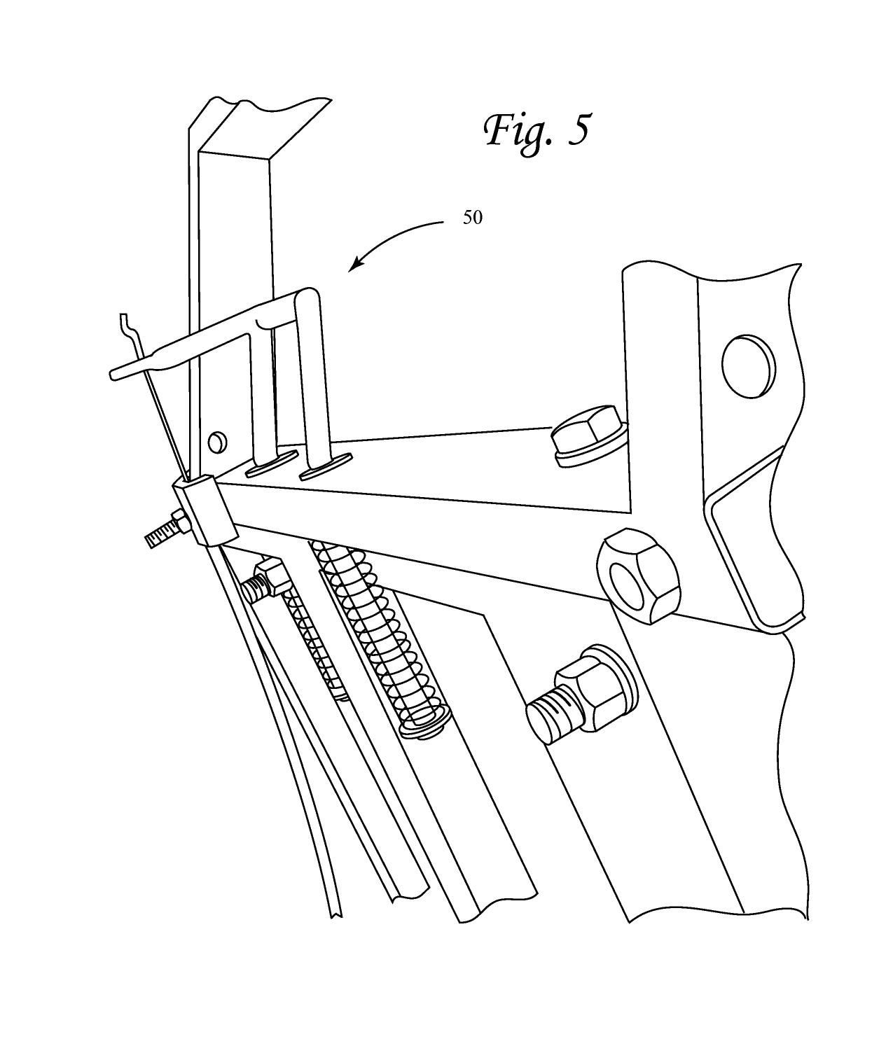

Referring to FIG. 5, the present invention further comprises a control unit 50 connected to and capable of controlling the locking unit 40. In the preferred embodiment, the control unit 50 is a manual release attached to the basket member 21. Springs are attached to the release to hold it in place until manipulated by the user. A cord connects the control unit 50 to the locking unit 40. When the user manipulates the release, the cord is pulled, which in turn pulls on the base of the locking unit 40. The force of the cord opposes the force exerted by the spring of the locking unit 40, which causes the base to rotate and frees the support members 20 to lift the cargo. One skilled in the art will recognize that many variations of the control unit 50 disclosed exist which would serve the same function. This disclosure is intended to disclose and does disclose those embodiments.

Referring to FIG. 3, the preferred embodiment of the present invention further to comprises a base member 30. The base member is adjustably attached to the attachment assembly of the vehicle mount 10A and further comprises both a proximate end 30A (pictured in FIG. 1) and a distal end 30B. In the preferred embodiment, the proximate end of the base member 30A is received by the attachment assembly 10A and secured by an attachment means such as a pin or like object. The base member 30 may be placed in a lowered position in which the distal end 30B is placed in connection with the ground. This has the effect of transferring any downward force exerted on the base member 30 due to the weight of cargo held in the basket member 21 directly into the ground. This configuration creates an extra support point to prevent cargo from exerting rotational force on the ATV wheel, which could create a potential tipping hazard when heavy cargo is lifted. The base member 30 attachment to the attachment assembly 10A should be adjustable to allow the base member 30 to be placed in a raised position. This allows the user to raise the distal end 30B for transport and prevents the distal end of the base member 30B from connecting with the ground when in a raised position.

In the preferred embodiment, the support members 20 are approximately five feet long when fully extended and the basket member 21 is approximately two and a half feet long by four feet wide. These dimensions have been found to work best with standard ATVs. However, one skilled in the art will understand that many other dimensions may be employed within the scope of the present invention depending on the desired application and the vehicle to which the invention is intended to be releaseably attached.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. A cargo lift apparatus, comprising:
a vehicle mount capable of being releaseably attached to a vehicle trailer hitch and further comprising an attachment assembly;
one or more support members pivotally attached to the attachment assembly of the vehicle mount;
a basket member capable of accepting and retaining cargo, and attached to the support members;
one or more dampers pivotally attached to the attachment assembly, pivotally attached to a support member, capable of storing rotational kinetic energy received from the attached support member, and capable of releasing stored energy as rotational kinetic energy into the attached support member; and
a locking unit attached to attachment assembly and capable of releasably locking the support members and attached damper in an energy storing position.

2. The cargo lift apparatus of claim 1, further comprising a control unit connected to and capable of controlling the locking unit.

3. The cargo lift apparatus of claim 2, wherein the basket member further comprises a handle.

4. The cargo lift apparatus of claim 2, further comprising one or more retaining members pivotally attached to the basket member and capable retaining cargo.

5. The cargo lift apparatus of claim 2, wherein the vehicle mount further comprises a protective shield for shielding the apparatus from foreign material ejected from the vehicle during transit.

6. The cargo lift apparatus of claim 2, further comprising a base member, said base member further comprising a proximate end and a distal end, wherein the proximate end of said base member is adjustably attached to the attachment assembly of the vehicle mount, wherein the base member may be placed in a lowered position in which the distal end is placed in connection with the ground for transferring downward force exerted on the base member into the ground, and wherein the base member may be placed in a raised position to prevent the base member from connecting with the ground.

7. The cargo lift apparatus of claim 2, wherein the support members further comprise a proximate portion, a distal portion, and an attachment means, wherein the proximate portion is attached to the basket member, the distal portion in pivotally attached to the attachment assembly of the vehicle mount, and the proximate portion is slideably received by the distal portion and adjustably retained in position by an attachment means.
